(19) United States
(12) Patent Application Publication
(10) Pub. No.: US 2007/0127074 A1
(43) Pub. Date: Jun. 7, 2007

(54) Device, method and program product for image processing

(76) Inventor: Ikuo Hayaishi, Matsumoto-Shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/598,851

(22) Filed: Nov. 13, 2006

(30) Foreign Application Priority Data
Nov. 15, 2005 (JP) 2005-329643

(51) Int. Cl. H04N 1/40

(52) U.S. Cl. 358/3.01; 358/518

(57) ABSTRACT

An image of a first image data PID is reduced to generate second image data PID2. The second image data PID2 is analyzed. A lookup table 104a is generated based on the analysis. The lookup table 104a is a table for image conversion that alters at least part of color of image data. The first image data is converted by referencing the lookup table 104a.

### BACKGROUND

1. Technical Field

The present invention relates to technology for processing image data.

2. Related Art

Automatic image processing has been performed according to the contents of image data subject to processing. For example, the parameter SV, which is determined based on the image data GD contained in the image file GF, and the image processing control information GC, which indicates image quality adjustment processing condition during imaging and is contained similarly in the image file GF, are fetched. Then, the respective R, G, and B tone curves are determined based on the parameter FP calculated from SV and GC. Automatic image quality adjustment is performed using those tone curves.

In another prior art, automatic color balance adjustment processing is performed based on the photographic subject focal distance and the lens focal distance contained in the Exif data area in the image data as well as on the size of the area occupied by the memory color in the image.

However, with the technologies noted above, there was no consideration regarding the point of a decrease in the volume of data handled for image processing while performing processing according to the respective image for subject.

The present invention addresses the reduction of the volume of data handled for image processing while performing processing according to the respective subject image.

The entire disclosure of Japanese patent application No. 2005-329643 of SEIKO EPSON is hereby incorporated by reference into this document.

### SUMMARY

To address the problem noted above, the present invention executes the following process when performing image processing. An image of a first image data is reduced to generate second image data. The second image data is analyzed. A lookup table is generated based on the analysis. The lookup table is a table for image conversion that alters at least part of color of image data. The first image data is converted by referencing the lookup table.

With this kind of aspect, a lookup table is generated based on second image data reflecting the contents of the first image data. Image conversion is performed while referencing that lookup table. Because of this, it is possible to perform processing according to the image that is the subject of image processing. On the other hand, the second image data is image data with a data volume lower than the first image data, obtained by reducing the image of the first image data. Because of this, during image processing, the processing load is smaller than an aspect for which the first image data is analyzed as is.

Note that when the first image data contains n color components tone values (n is an integer of 2 or greater), it is preferable that the lookup table be an n dimension lookup table having a combination of n types of color component tone values as the input values and output values. Then, when generating that lookup table, it is preferable to perform the following kind of processing.

The n tone curves are generated based on the analysis. The n tone curves respectively have discrete tone values of one of the n color components as input tone values and output tone values. The n dimension lookup table is generated based on the n tone curves. The n dimension lookup table is an n dimension table for which a number of tones of input values is lower than the tone curve for at least one color component. In the determination of at least part of the input tone values of the lookup table, it is preferable that at least part of the input tone values of the n dimension lookup table are selected from among the input tone values of the tone curve based on the increasing ratio of the output tone values associated with the input tone values of the tone curve.

Also, when generating the n dimension lookup table, it is possible to use an aspect performing the following kind of processing. When at least part of the input tone values of the tone curve are predetermined as candidates of the input tone values for the n dimension lookup table and are divided into a first group and a second group for which corresponding output tone value increase rate is larger than that of the first group, input tone values in the second group are determined as at least part of the input tone values of the n dimension lookup table.

Using this kind of aspect, compared to an aspect of generating the n dimension lookup table which has all input tone values of the tone curves as is for the input tone values, it is possible to reduce the information volume of the lookup table. Also, because input tone values for which the increase rate of the output tone value correlating to each input tone value of the tone curve is larger is set as the input tone value of the n dimension lookup table, it is possible to reduce the level of decrease in quality in the image processing due to a reduction in input tone values. Note that with this aspect, it is acceptable as long as at least part of the input tone values contained in the second group is set as at least part of the input tone values that the n dimension lookup table has.

The following process can be performed when generating the n dimension lookup table. Specifically, a plurality of input tone values at fixed intervals among the tone curve input tone values that are the input tone values as candidates described above are correlated to each input tone value, and the difference of the output tone values between each input tone value and the adjacent input tone values is calculated as the rate of increase. Then, the input tone values of a second group in which the correlated difference is greater than that of the first group are set as at least part of the input tone values that the n dimension lookup table has.

In this aspect, the difference is calculated as the rate of increase using the output tone values of the input tone value candidates. Thus, compared to an aspect for which for each input tone value, an input tone value space is set separately and the increase rate is calculated, it is possible to simply set determine lookup table input tone values.

The following process should be used when determining at least part of the input tone values that the n dimension lookup table has from among the plurality of input tone values at fixed intervals. Input tone values associated with differences greater than a predetermined threshold are selected as the input tone values of the n dimension lookup table.

In this aspect, input tone values with less change than a given reference among the input tone values of the tone curve are not selected as lookup table input tone values. Thus, it is possible to reduce the amount of data in the lookup table while reducing the decrease in image quality during image processing. Note that the input tone values correlated with a difference greater than the threshold value are input values of the second group described above.

Also, when determining at least part of the input tone values that the n dimension lookup table has from among the plurality of input tone values having a fixed interval, it is preferable to perform the following kind of processing. As at least part of the input tone values of the n dimension lookup table, LS input tone values (LS is a positive integer and equal or less than a predetermined positive integer L) which are associated with LS largest differences are selected from among the plurality of input tone values having the fixed interval.

With this kind of aspect, compared to the aforementioned aspect for which the input tone values are selected based on a threshold value, it is possible to more surely reduce the lookup table data volume. Note that the maximum L input tone values in the sequence for which the correlated difference is large are the input tone values of the second group described above.

In generating at least one of the n tone curves, the following process may be preferable. In generating at least one of the n tone curves, a reference output tone value Vor associated with a reference input tone value Vir is determined based on the analysis. Output tone values associated with input tone values other than the reference input tone value Vir are determined such that an output tone value Voa associated with an input tone value Via is closer to the reference output tone value Vor than an output tone value Vob associated with an input tone value Vib. The input tone values Via and Vib fulfill the following equations.
|Via−Vir|<|Vib−Vir|
(Via−Vir)×(Vib−Vir)>0.

In other words, a reference output tone value associated with a reference input tone value having a predetermined value is determined based on the analysis. Output tone values associated with input tone values other than the reference input tone value are determined such that the closer the input tone value is to the reference input tone value, the output tone value will have a value closer to the reference output tone value for input tone values which are present in a same greater or smaller side of the reference input tone value.

With this kind of aspect, it is possible to determine the tone curve shape so that the brightness of the image color is altered reflecting the content of the image that is the subject of the image processing. As a result, it is possible to generate a lookup table such that the brightness of the color of the image is altered reflecting the content of the image that is the subject of the image processing.

In generating at least one of the n tone curves, the following process may be preferable. A first reference output tone value Vor1 associated with a first reference input tone value Vir1 is decreased based on the analysis. A second reference output tone value Vor2 associated with a second reference input tone value Vir1 is increased based on the analysis. The second reference input tone value Vir2 is larger than the first reference input tone value Vir1. Output tone values associated with input tone values other than the first reference input tone value Vir1 and the second reference input tone value Vir2 are determined such that an output tone value Voa associated with an input tone value Via is closer to the reference output tone value Vor1 than an output tone value Vob associated with an input tone value Vib, and an output tone value Voc associated with an input tone value Vic is closer to the reference output tone value Vor2 than an output tone value Vod associated with an input tone value Vid. The input tone values Via, Vib, Vic and Vid fulfill the following equations.
|Via−Vir1|<|Vib−Vir1|
(Via−Vir1)×(Vib−Vir1)>0
|Vic−Vir2|<|Vid−Vir2|
(Vic−Vir2)×(Vid−Vir2)>0.

In other words, a first reference output tone value associated with a first reference input tone value is decrease based on the analysis. A second reference output tone value associated with a second reference input tone value is increased based on the analysis. The second reference input tone value has a value larger than that of the first reference input tone value. Output tone values associated with input tone values other than the first and second reference input tone values are determined such that the closer the input tone value is to the first reference input tone value, the output tone value will have a value closer to the first reference output tone value for input tone values which are present in a same greater or smaller side of the first reference input tone value, and the closer the input tone value is to the second reference input tone value, the output tone value will have a value closer to the second reference output tone value for input tone values which are present in a same greater or smaller side of the second reference input tone value.

With this kind of aspect, it is possible to determine the tone curve shape such that the contrast of the image is enhanced according to the content of the image that is the subject of the image processing. As a result, it is possible to generate a lookup table such that the contrast of the image is enhanced according to the content of the image that is the subject of the image processing.

In generating at least one of the n tone curves, the following process may be preferable. Reference output tone values Vori (i=1 to n) respectively associated with a same reference input tone value Vir in the n tone curves are determined within a specified range. Output tone values associated with input tone values other than the reference input tone value Vir are determined such that an output tone value Voai(i=1 to n) associated with an input tone value Viai(i=1 to n) is closer to the reference output tone value Vori than an output tone value Vobi (i=1 to n) associated with an input tone value Vibi (i=1 to n) in generating the ith tone curve. The input tone values Viai and Vibi fulfill the following equations.
|Viai−Vir|<|Vibi−Vir|
(Viai−Vir)×(Vibi−Vir)≧0

In other words, reference output tone values respectively associated with a same reference input tone value in the n tone curves are determined within a specified range. Output tone values associated with input tone values other than the reference input tone values in the respective n tone curves are determined such that the closer the input tone value is to the reference input tone value, the output tone value will have a value closer to the reference output tone value for input tone values which are present in a same greater or smaller side of the reference input tone value.

With this kind of aspect, it is possible to generate a lookup table such that the hue does not greatly change due to color conversion.

Note that the present invention can be realized with various aspects, for example it is possible to realize aspects such as image processing methods and image processing devices, image data generating methods and image data generating devices, color conversion methods and color conversion devices, printing methods and printing devices, printing control methods and printing control devices, as well as computer programs for realizing the functions of those method or devices, recording media on which are recorded those computer programs, data signals which are embodied within carrier waves containing those computer programs, and the like.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a block diagram showing the constitution of the software of the printing system of the first aspect;

FIG. 2 is a flow chart representing the process of the LUT generating module 102;

FIG. 3 shows part of the contents of the memory color table 105;

FIG. 4 is a flow chart showing the procedure for determining the subject memory color parameters representing the contents of adjustment in relation to the memory colors;

FIG. 5 is a flow chart showing the procedure for generating the three dimensional lookup table 104a at step S200 of FIG. 2;

FIG. 6A shows an example of the tone curve generating method at step S220 in FIG. 5;

FIG. 6B shows an example of the tone curve generating method at step S220 in FIG. 5;

FIG. 7 is a flow chart showing the procedure for determining the input tone values of the three dimensional lookup table 104a at step S230 in FIG. 5;

FIG. 8 shows the method of determining the input tone values of the three dimensional lookup table 104a on the tone curve C1;

FIG. 9 shows as black points surrounded by circles the grid positioned on the flat surface of the blue input tone value Vbi=0 for the three dimensional lookup table 104c;

FIG. 10 is a flow chart showing the procedure for performing alteration for the output tone values of the grid contained in the range of memory colors among the three dimensional lookup table 104c;

FIG. 11 shows the range of memory colors in the three dimensional lookup table 104c;

FIG. 12 shows an example of the alteration contents of the tone values at step S256;

FIG. 13 shows the memory color table 105;

FIG. 14 is a flow chart showing the procedure of the tone curve generating method for the second embodiment;

FIG. 15A shows an example of the red tone curve generating method for step S222 in FIG. 14;

FIG. 15B shows an example of the red tone curve generating method for step S222 in FIG. 14; and

FIG. 16 shows an example of the tone curve alteration method at step S224 in FIG. 14.

### DESCRIPTION OF EXEMPLARY EMBODIMENT

### A. First Embodiment

A1. Device Overall Constitution:

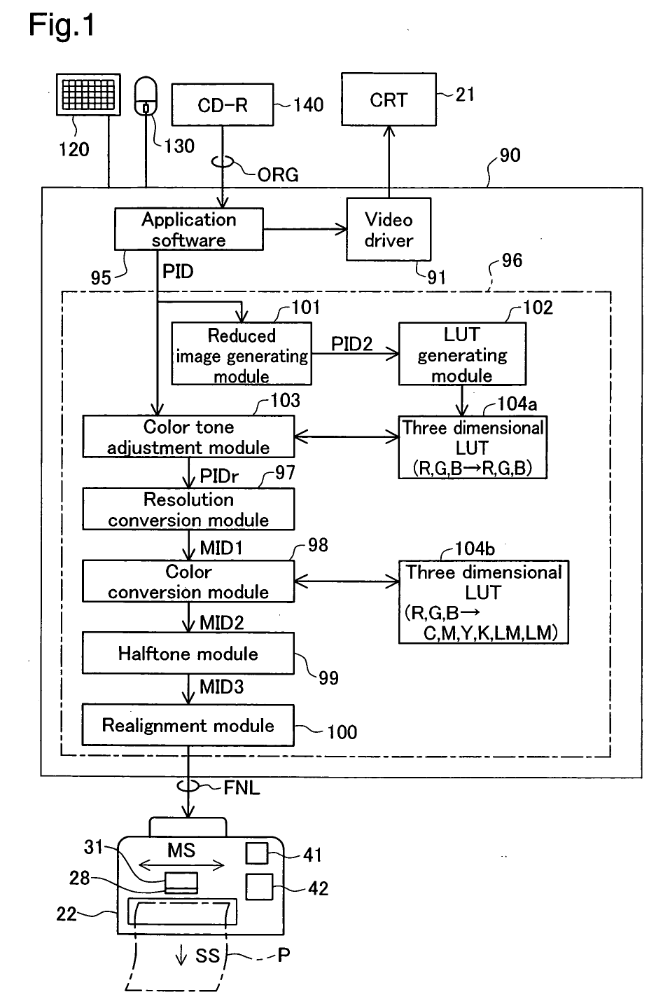

FIG. 1 is a block diagram showing the software constitution of the printing system of the first embodiment. An application program 95 is operated under the control of a given operating system in the computer 90. Also, a video driver 91 and a printer driver 96 are incorporated in the operating system.

The application program 95 reads from a CD-R 140 original image data ORG consisting of three color components red (R), green (G), and blue (B) according to instructions from the user input from a mouse 130 or a keyboard 120. Then, processing such as retouching of the image is performed on the original image data ORG according to the user instructions. The application program 95 displays the image, for which processing was performed, on a CRT display 21 via the video driver 91. Also, when the application program 95 receives printing instructions from the user, it outputs the printing instructions to the printer driver 96, and the processed image is output to the printer driver 96 as the primary image data PID. The primary image data PID is image data for which the color of each pixel is represented by the color system sRGB. In more specific terms, the primary image data PID is image data having tone values (0 to 255) of the color components red (R), green (G), and blue (B) for each pixel.

The printer driver 96 receives the primary image data PID from the application program 95, and converts this to printing image data FNL that can be processed by the printer 22 (here, multileveled signals for the six colors of cyan, magenta, yellow, black, light cyan, and light magenta).

With the example shown in FIG. 1, the printer driver 96 are comprised a reduced image generating module 101, a lookup table generating module 102, a color tone adjustment module 103, a resolution conversion module 97, a color conversion module 98, a halftone module 99, and a realignment module 100.

The reduced image generating module 101 generates a reduced image data PID2 based on the primary image data PID received from the application program 95. The reduced image data PID2 is image data that represents the same subject as the primary image data PID, for which the number of pixels constituting the image is lower than that of the primary image data PID.

The lookup table generating module 102 (hereafter noted as “LUT generating module 102”) analyzes the reduced image data PID2 and generates a three dimensional lookup table 104a based on those analysis results. The three dimensional lookup table 104a is a lookup table that has a combination of red, green, and blue tone values Vri, Vgi, and Vbi as the input values, and has a combination of red, green, and blue tone values Vro, Vgo, and Vbo as the output values. The three dimensional lookup table 104a has output values (Vro, Vgo, and Vbo) representing different colors from the input values for at least part of the input values (Vri, Vgi, and Vbi).

The color tone adjustment module 103 generates image data PIDr by converting the primary image data PID received from the application program 95 while referencing the three dimensional LUT 104a. The image data PIDr has the tone values of the red (R), green (G), and blue (B) color components for each pixel, and is image data of the same pixel count as the primary image data PID.

Note that in the image processing for the reduced image generating module 101, the lookup table generating module 102, and the color tone adjustment module 103, the user is able to input instructions via the mouse 130 or the keyboard 120 at a specified timing. However, even when there are no instructions from the user, the image processing by the reduced image generating module 101, the lookup table generating module 102, and the color tone adjustment module 103 will be performed automatically.

The resolution conversion module 97 converts the image data PIDr resolution to the resolution when performing printing with the printer 22.

The color conversion module 98 converts the image data MID1 to the image data MID2 while referencing the three dimensional lookup table 104b of the color conversion table 104. The image data MID2 is the image data in which the color of each pixel are represented with the tone values of the color strengths of cyan (C), magenta (M), yellow (Y), black (K), light cyan (LC), and light magenta (LM) used by the printer 22. Note that the three dimensional lookup table 104b is a lookup table having a combination of the red, green, and blue tone values as the input values, and has a combination of the cyan, magenta, yellow, black, light cyan, and light magenta tone values as the output values. This three dimensional lookup table 104b is not generated based on the reduced image data PID2 or the primary image data PID, but rather is prepared in advance without reference to the primary image data PID.

By performing halftone processing on the image data MID2 in which the strength of each color of each pixel is represented by the tone values of each color, the halftone module 99 converts to image data MID3 (also called “print data” or “dot data”) for which the strength of each color is represented by the presence or absence of dots for each pixel.

The image data MID3 generated in this way is realigned in the data sequence to be transferred to the printer 22 by the realignment module 100, and is output as the final printing image data FNL.

The printer 22 is constituted from a mechanism by which paper P is transported by a paper feed motor, a mechanism by which a carriage 31 is moved back and forth by a carriage motor in the direction MS perpendicular to the transport direction SS of the paper P, a printing head 28 for performing ink spraying and dot formation which is equipped on the carriage 31, a P-ROM 42 in which many types of setting data are stored, and a CPU 41 for controlling the paper feed motor, the carriage motor, the printing head 28, the P-ROM 42, and the operating panel 32. The printer 22 executes printing by receiving the printing image data FNL, and forms dots on the printing medium with cyan (C), magenta (M), yellow (Y), black (K), light cyan (LC), and light magenta (LM) according to the printing image data FNL.

Note that “light cyan” is an ink color with the same hue as cyan but with a higher lightness than cyan. Light cyan and cyan can be mutually interchanged when reproducing some colors. Specifically, by recording light cyan and cyan at respectively different recording rates, it is possible to express cyan color components of about the same strength.

Also, “light magenta” is an ink color with the same hue as magenta but a higher lightness than magenta. Light magenta and magenta can be mutually interchanged when reproducing some colors. Specifically, by recording light magenta and magenta at respectively different recording rates, it is possible to express magenta color components of about the same strength.

Note that with this specification, the “printing device” indicates only the printer 22 with the narrow definition, but with a broad definition, expresses the overall printing system including the computer 90 and the printer 22.

A2. Process in the LUT Generating Module:

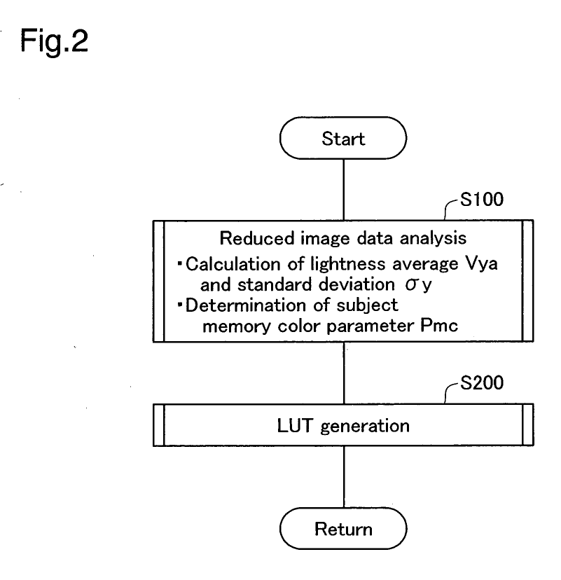

FIG. 2 is a flow chart representing the process in the LUT generating module 102. At step S100, the LUT generating module 102 first analyzes the reduced image data PID2, and calculates the parameters that represent the characteristics of the reduced image PID2.

At step S100, the LUT generating module 102 acquires the lightness Vy for each pixel of the reduced image data PID2 using the following formula, for example. Note that Vr is the red tone value of each pixel, Vg is the green tone value of each pixel, and Vb is the blue tone value of each pixel.
Vy=0.30Vr+0.59Vg+0.11Vb (1)

Then, the average value Vya of the lightness Vy for each pixel and the standard deviation σy are acquired for the reduced image data PID2. The average value Vya of the lightness Vy for each pixel and the standard deviation oy of the reduced image data PID2 obtained in this way represent the characteristics of the reduced image data PID2, and thus are the parameters that represent the characteristics of the primary image data PID.

Also, at step S100, the LUT generating module 102 sets the color range for performing adjustment based on the memory color, and sets the subject memory color parameter Pmc correlating to that color range. The subject memory color parameter Pmc is also determined based on the characteristics of the reduced image data PID2, and is the parameter that represents the characteristics of the reduced image data PID2.

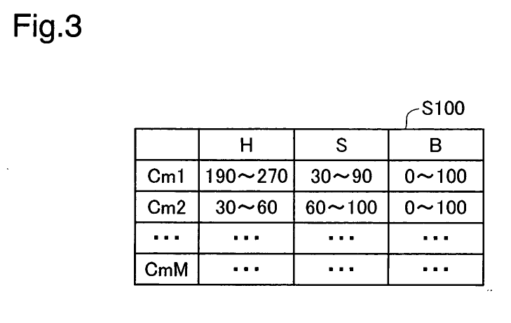

FIG. 3 shows part of the contents of a memory color table 105. The LUT generating module 102 has the memory color table 105. The LUT generating module 102 determines the subject memory color parameter Pmc based on this memory color table 105. The memory color table 105 stores the range of the hue (H), the saturation (S), and the brightness (B) for the M (M is an integer of 2 or greater) color ranges Cm1 to CmM. For example, in FIG. 3, the color range Cm1 is a color for which the range of H=190 to 270°, S=30 to 90%, and B=0 to 100%. Note that the color range Cm1 is a sky blue color. The memory color table 105 similarly stores a plurality of color ranges Cm2 to CmM respectively for tree green color, human skin color, and the like.

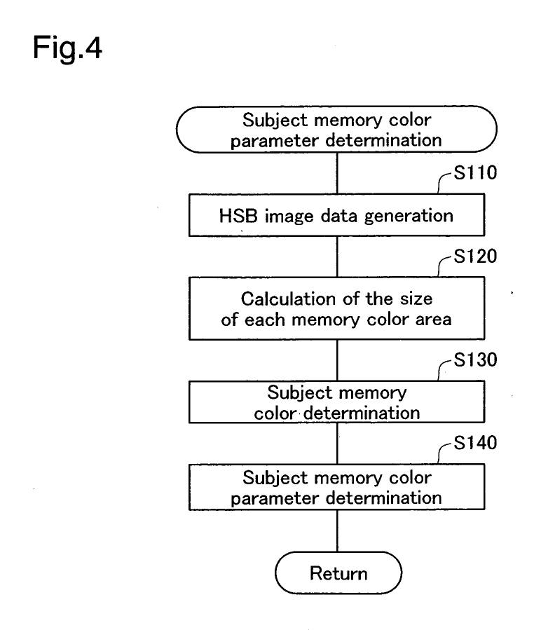

FIG. 4 is a flow chart showing the procedure for determining the subject memory color parameters representing the adjustments relating to the memory color. At step S10, the LUT generating module 102 first converts the reduced image data PID2 represented by the sRGB colorimetric system to HSB image data PID3 represented by the HSB calorimetric system. Then, at step S120, the size of the areas, in the image of the HSB image data PID3, which are occupied respectively by the colors included in the color range Cm1 to CmM of the memory color (see FIG. 3) is calculated. The size of the areas is expressed by pixel count.

Then, in step S130, the color range of the memory color which occupies the largest area in the image of HSB image data PID3 is determined as the subject memory color that is subject to adjustment relating to memory colors. The HSB image data PID3 is the data generated by converting the reduced image data PID2, and the reduced image data PID2 is the image generated by reducing the primary image data PID. Thus, the colors of the color range determined as the subject memory color occupy the broadest area within the primary image data PID image and within the reduced image data PID2 image.

At step S140 in FIG. 4, a number of the subject memory color is stored as the subject memory color parameter Pmc. For example, when the color range Cm1 is selected as the subject memory color, Pmc=1. When the color range Cmi (i=1 to M) is selected as the subject memory color, Pmc=i. With step S100 in FIG. 2, the LUT generating module 102 determines the parameters Vya, σy, and Pmc that represent the characteristics of the reduced image data, by performing a process such as that noted above, for example.

At step S200 in FIG. 2, the LUT generating module 102 generates the three dimensional lookup table 104a based on the plurality of parameters Vya, σy, and Pmc obtained as a result of analysis of the reduced image data PID2 at step S200.

With the first embodiment, rather than analyzing the primary image data PID itself, the reduced image data PID2 is analyzed, and the three dimensional lookup table 104a is generated based on those analysis results. Because of this, the processing load is smaller than with the aspect that generates the three dimensional lookup table by analyzing the primary image data PID itself. Also, the reduced image data PID2 is an image obtained by reducing the primary image data PID. Because of this, the three dimensional lookup table 104a is generated reflecting the characteristics of the primary image data PID.

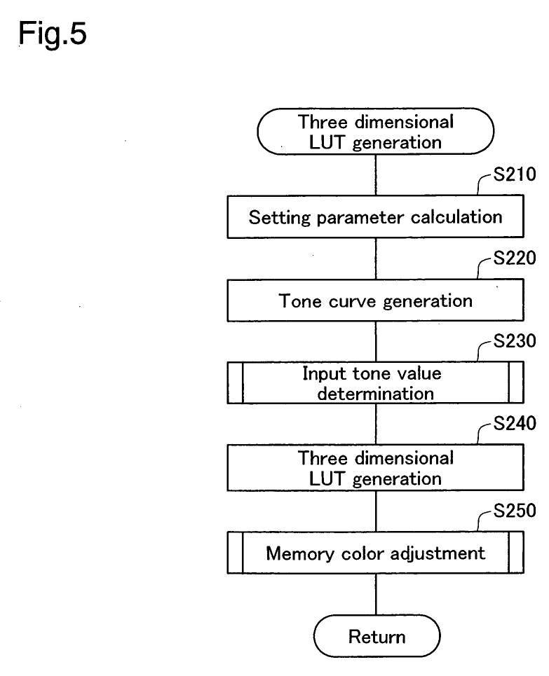

FIG. 5 is a flow chart showing the procedure for generating the three dimensional lookup table 104a at step S200 in FIG. 2. At step S210, first, based on the average value Vya of the lightness Vy and the standard deviation oy obtained at step S100, the setting parameters for determining the tone curve shape are calculated.

The LUT generating module 102 calculates the lightness adjustment parameter dl as the tone curve setting parameter using formula (2) below. The lightness adjustment parameter dl is the parameter for having the finally generated three dimensional lookup table 104a which is able to adjust the brightness of the image to the target brightness. Note that a in formula (2) is a positive constant. Vyc is the target value of the average lightness, and for example, is the median value of the lightness tone values. With the first embodiment, the lightness tone value is 0 to 255 from formula (1), so Vyc is 128.
d1=a×(Vyc−Vya) (2)

Also, at step S210, the LUT generating module 102 calculates the contrast adjustment parameter dc as the setting parameter with formula (3) or (4) below. The contrast adjustment parameter dc is the parameter for having the finally generated three dimensional lookup table 104a which is able to adjust the contrast of the image appropriately. Note that b and σy0 in formula (3) are positive constants. σy0 is the target value of the standard deviation of the brightness tone values.
dc=b×(σy0−σy) (when σy<σy0) (3)
dc=0 (when σy≧σy0) (4)

At step S220, the LUT generation module 102 generates the tone curve based on the lightness adjustment parameter dl and the contrast adjustment parameter dc. The tone curve generated at step S220 has discrete input values and output values. Note that with the first embodiment, the same tone curve is used in relation to the red, green, and blue tone value conversion.

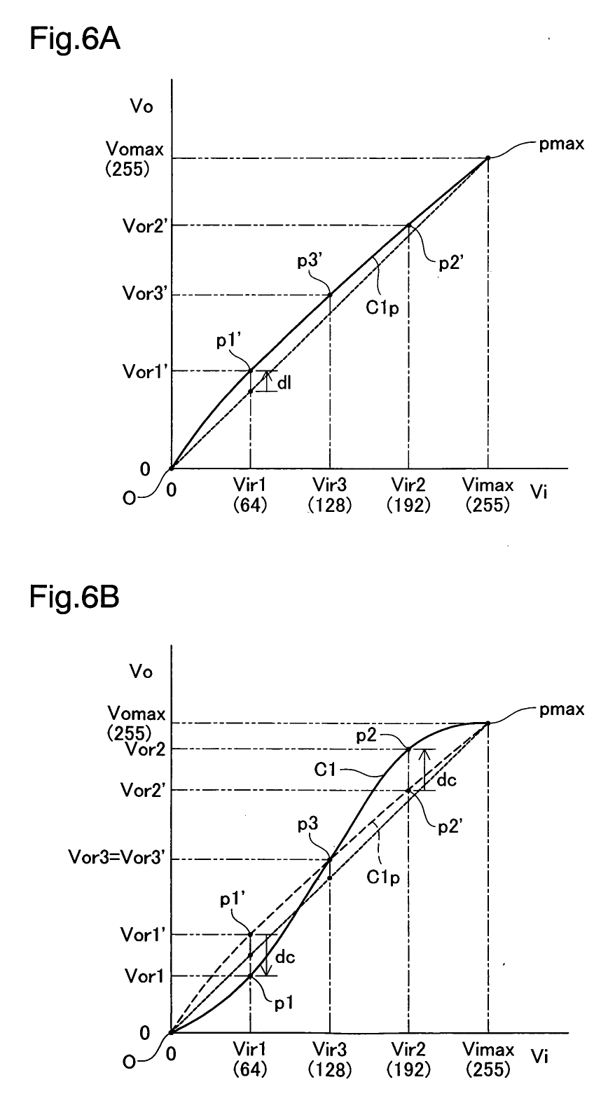

FIGS. 6A and 6B are drawings showing an example of the tone curve generating method at step S220 in FIG. 5. The horizontal axes of the graphs represent the red, green, and blue input tone values Vi, and the vertical axes represent their output tone values Vo. At step S220 in FIG. 5, the LUT generating module 102 first determines the interim output tone value Vor1′ of the reference input tone value Vir1=64 which is the tone value ¼ from the bottom of the range that the input tone value can have, using the formula (5) below.
Vor1′=Vir1+dl (5)

Specifically, when the lightness average value Vya is less than Vyc (128), the reference input tone value Vir1 is increased by the amount |dl|. Meanwhile, when the lightness average value Vya is greater than Vyc, the reference input tone value Vir1 is reduced by the amount |dl|. Then, the interim tone curve C1p is generated as the spline curve that passes through point O (0, 0), point p1′ (Vir1, Vor1′), and point pmax (Vimax, Vomax). Vimax is the maximum value of the input tone values, and Vomax is the maximum value of the output tone values. Note that in FIG. 6A an example when the lightness average value Vya is smaller than Vyc=128 is shown.

After that, the LUT generating module 102 further determines the reference output tone value Vor1 corresponding to the reference input tone value Vir1=64 which is the tone value ¼ from the bottom using formula (6) below.
Vor1=Vor1′−dc (6)

From formula (3), (4), and (6), when the lightness standard deviation σy is less than σy0, the output tone value of the reference input tone value Vir1 decreases by dc. On the other hand, when the lightness standard deviation is equal to or greater than σy0, the output tone value of the reference input tone value Vir1 stays as is as the interim output tone value Vo1′. Note that in FIG. 6B an example when the lightness standard deviation σy is less than σy0 is shown.

Also, the LUT generating module 102 determines the output tone value Vo2 of the reference input tone value Vir2=192 which is the tone value ¼ from the top of the range that the input tone value can have, using formula (7) below. Note that Vo2′ is the output tone value of the reference input tone value Vir2 in the interim tone curve C1p (see FIG. 6A) generated based on the lightness adjustment parameter dl.
Vor2=Vor2′+dc (7)

From formula (3), (4), and (7), when the lightness standard deviation σy is less than σy0, the output tone value of the reference input tone value Vir2 increases by dc. On the other hand, when the lightness standard deviation is σy0 or greater, the output tone value of the reference input tone value Vir2 is left as is as the interim output tone value Vo2′. Note that in FIG. 6B an example when the lightness standard deviation σy is less than σy0 is shown.

Meanwhile, with the LUT generating module 102, the output tone value Vo3 of the reference input tone value Vir3=128, which is the tone value ½ from the bottom, is the same value as the output tone value Vo3′ of the reference input tone value Vir3 in the interim tone curve C1p.

Then, the LUT generating module 102 generates the tone curve C1 as the spline curve that passes through the point O (0, 0), point p1 (Vir1, Vor1), point p3 (Vir3, Vor3), point p2 (Vir2, Vor2), and point pmax (Vimax, Vomax). As a result, the tone curve is determined as follows.

When input tone values Via and Vib other than the reference input tone value Vir1 fulfill the following equations, output tone values Voa and Vob respectively associated with the input tone values Via and Vib are determined such that the output tone value Voa is closer to the reference output tone value Vor1 than the output tone value Vob.
|Via−Vir1|<|Vib−Vir1|
(Via−Vir1)×(Vib−Vir1)>0

When input tone values Vic and Vid other than the reference input tone value Vir2 fulfill the following equations, output tone values Voc and Vod respectively associated with the input tone values Vic and Vid are determined such that the output tone value Voc is closer to the reference output tone value Vor2 than the output tone value Vod.
|Vic−Vir2|<|Vid−Vir2|
(Vic−Vir2)×(Vid−Vir2)>0

When input tone values Vie and Vif other than the reference input tone value Vir3 fulfill the following equations, output tone values Voe and Vof respectively associated with the input tone values Vie and Vif are determined such that the output tone value Voe is closer to the reference output tone value Vor3 than the output tone value Vof.
|Vie−Vir3|<|Vif−Vir3| and
(Vie−Vir3)×(Vif−Vir3)>0.

In other words, for the input tone values which are present in the same smaller or greater side relative to the reference input tone value Vir1, the closer the input tone value is to the reference input tone value Vir1, the output values are made to have values closer to the reference output tone value Vor1. Also, for the input tone values which are present in the same smaller or greater side relative to the reference input tone value Vir2, the tone curve is determined such that the closer the input tone values are to the reference input tone value Vir2, the output values are made to have values closer to the reference output tone value Vor2. For the input tone values which are present in the same smaller or greater side relative to the reference input tone value Vir3, the tone curve is determined such that the closer the input tone values are to the reference input tone value Vir3, the output values are made to have values closer to the reference output tone value Vor3 corresponding to the reference input tone value Vir3. At step S220 in FIG. 5, the tone curve is generated as described above.

At step S230 in FIG. 5, the tone curve generated at step S220 is analyzed, and the input tone value of the three dimensional lookup table 104a is determined.

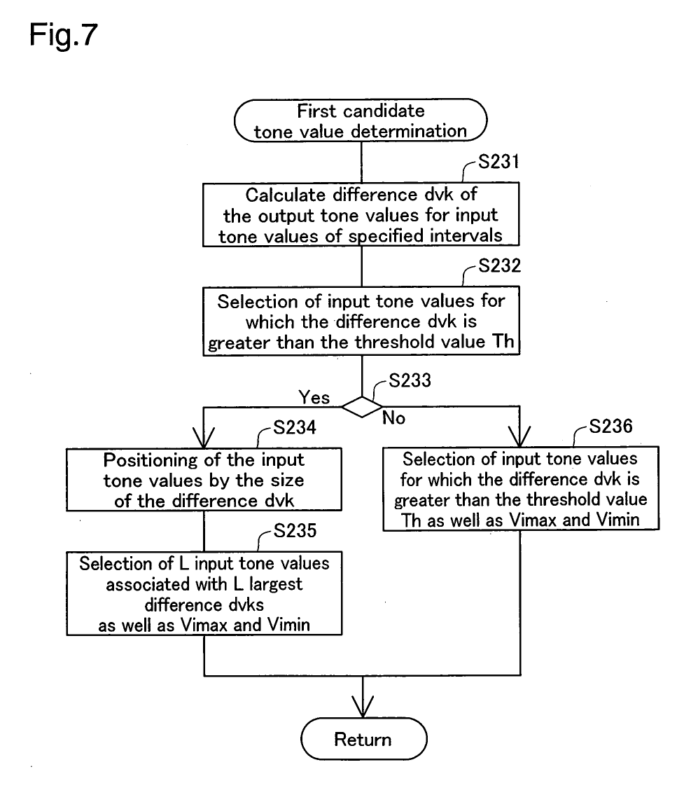

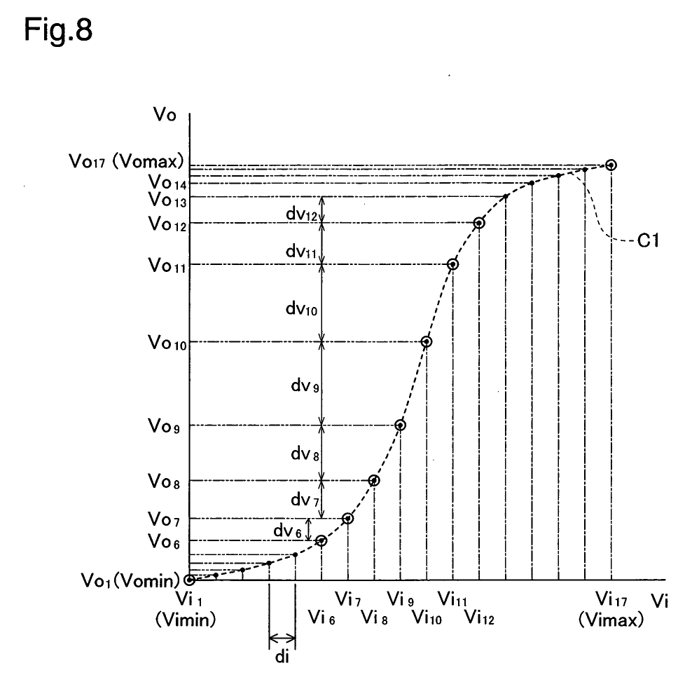

FIG. 7 is a flow chart showing the procedure for determining the input tone value of the three dimensional lookup table 104a at step S230 of FIG. 5. FIG. 8 shows the method of determining the input tone value of the three dimensional lookup table 104a using the tone curve C1. At step S231 of FIG. 7, first the difference is found between each corresponding output tone value for a plurality of input tone values having a constant interval di from each other in the tone curve, and the output tone value of the next smaller input tone value. The difference dvₖ is determined, for example, between each corresponding output tone value V₀ₖ for the input tone values Viₖ (k=1 to 17) having a 16 tone interval of 0 to 255 from each other, and the output tone value Vok+1 of the next greater 16 one input tone value Vik+1. Each difference dvₖ is correlated to the respective input tone value Viₖ. In FIG. 8, the tone curve C1 is shown by a dashed line, and the points on the tone curve corresponding to the input tone values Viₖ are shown by black dots.

At step S232 in FIG. 7, the input tone values Viₖ having a difference dvₖ greater than the threshold value Th are selected. At step S233, it is determined whether the number of input tone values Viₖ for which the difference dvₖ is larger than the threshold value Th is greater than L (L is a positive integer). When the determination result is Yes, the process proceeds to step S234. At step S234, the input tone values Viₖ selected at step S232 are positioned in the order of the greater difference dvₖ. Then, at step S235, L input tone values with the L largest difference dvₖs are determined as the input tone values of the three dimensional lookup table 104a.

L is a number that is smaller by 2 than the number Nmax predetermined as the maximum number of input tone values of the three dimensional lookup table 104a. Nmax is an integer of 3 or more. In the first embodiment, for example, when Nmax is 9, L is 7. In the example in FIG. 8, at step S235 of FIG. 7, the 7 input tone values of Vi6 to Vi12 are selected based on the magnitude of the difference dvₖ.

Also, at step S235 in FIG. 7, the minimum input tone value Vimin and the maximum input tone value Vimax are also selected as input tone values of the three dimensional lookup table 104a. After that, the processing ends. In the example in FIG. 8, because Vi1 and Vi17 are Vimin and Vimax, respectively, Vi1 and Vi17 are also selected in addition to Vi6 to Vi12 as input tone values of the three dimensional lookup table 104a. In FIG. 8, the points on the tone curve corresponding to the tone values Vik selected as the input tone values of the three dimensional lookup table 104a of the input are indicated by circles.

Meanwhile, at step S233, when there are L or fewer input tone values selected at step S232, the process proceeds to step S236. At step S236, all the input tone values selected at step S232 and the minimum input tone value Vimin and maximum input tone value Vimax are selected as the first candidate tone values. Specifically, in the procedure in FIG. 7, the maximum L input tone values are selected based on the difference dvk. At step S230 of FIG. 5, the maximum Nmax input tone values of the three dimensional lookup table 104a are determined in the manner described above.

At step S240 of FIG. 5, the three dimensional lookup table 104c is generated from the input tone values determined at step S230 and the output tone values corresponding to those. The three dimensional lookup table 104c has red, green, and blue tone values as the input values and has red, green, and blue tone values as the output values.

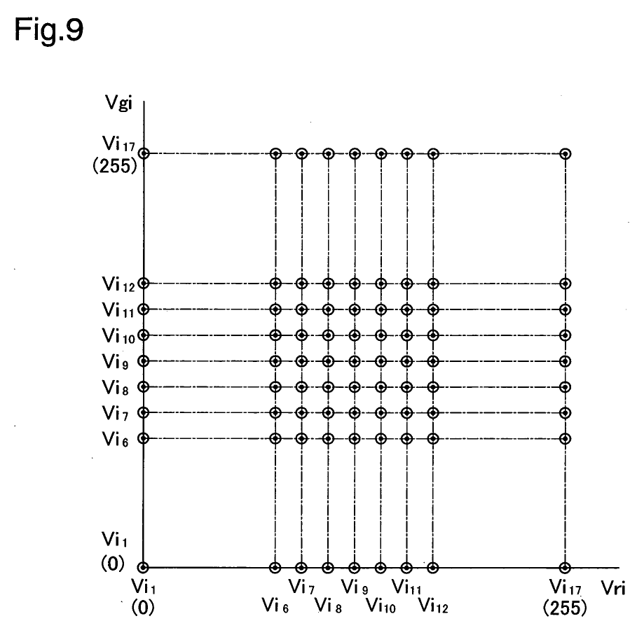

In the three dimensional lookup table 104c in FIG. 9, a grid positioned on a blue plane in which the input tone value Vbi=0 is represented by black points enclosed in circles. The “grid” comprises point specified in color space by a combination of input tone values. The red, green, and blue input tone values of the three dimensional lookup table 104c are respectively the Nmax input tone values determined at step S230. In the example in FIG. 8, these are the nine tone values of Vi1, Vi6 to Vi12, and Vi17. In FIG. 9, the red input tone values and the green input tone values are shown by Vi1, Vi6 to Vi12, and Vi17 respectively.

The output tone values of each color component for each grid of the three dimensional lookup table 104c are determined based on the tone curve of each color component. For example, the blue output tone values for all grids in which the blue input tone values Vbi=Vi1, specifically, 0, are Vo1, that is, 0, corresponding to Vi1 in the blue tone curve determined in step S220 of FIG. 5. The blue output tone values for all grids in which the blue input tone value is Vi6 are Vo6 corresponding to Vi6 in the blue tone curve. This is also the same for the red and green output tone values.

At step S250 of FIG. 5, the memory color for the three dimension lookup table 104c is adjusted to generate the three dimension lookup table 104a. In specific terms, the output tone values of the grid included in the memory color range of the three dimensional lookup table 104c generated at S240 are modified to generate the three dimensional lookup table 104a.

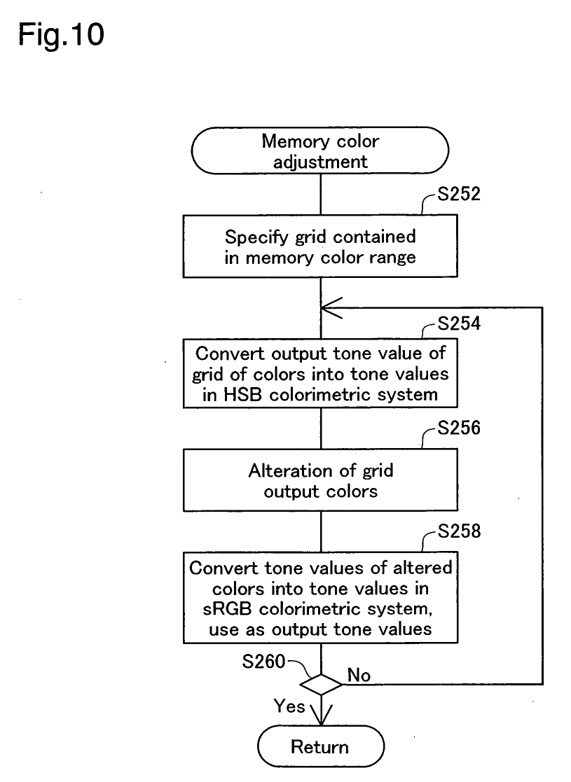

FIG. 10 is a flow chart showing the procedure for modifying the output tone values of the grid contained in the memory color range of the three dimensional lookup table 104c. At step S252, first, the grid contained in the color range of the memory color subject to adjustment among the grids of the three dimensional lookup table 104c is specified. This color range is the color range of memory colors corresponding to the subject memory color parameter Pmc determined at step S100 of FIG. 2. In specific terms, in the sRGB color space, this is a range in which a polyhedron is determined, the vertices of which are 8 points pc1 (Vcr1, Vcg1, Vcb1) to pc8 (Vcr8, Vcg8, Vcb8) corresponding to the color range Cmi of the subject memory color parameter Pmc.

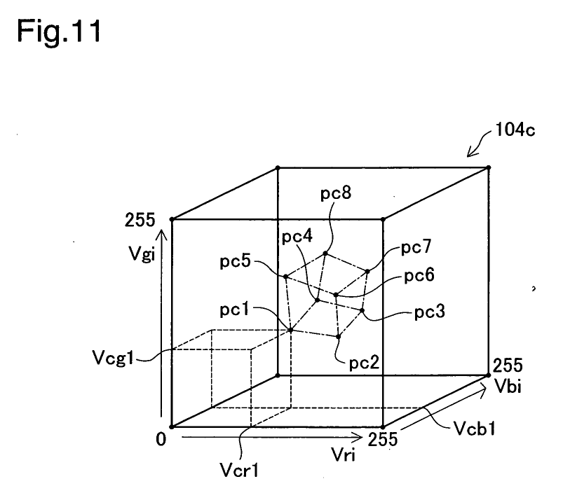

FIG. 11 shows the range of memory colors of the three dimensional lookup table 104c. Points pc1 to pc8 are determined as described below.

As shown in the memory color table 105 of FIG. 3, the color range of the memory colors is determined by the range for H, S, and B. In case where the color range of the memory colors are H=Hmin to Hmax, S=5 min to Smax, and B=Bmin to Bmax, the following eight colors (=2ⁿ) c1 to c8 are determined by a combination of the numerical values at both ends of these ranges.

c1: (H, S, B)=(Hmin, 5 min, Bmin)

c2: (H, S, B)=(Hmin, 5 min, Bmax)

c3: (H, S, B)=(Hmin, Smax, Bmin)

c4: (H, S, B)=(Hmin, Smax, Bmax)

c5: (H, S, B)=(Hmax, 5 min, Bmin)

c6: (H, S, B)=(Hmax, 5 min, Bmax)

c7: (H, S, B)=(Hmax, Smax, Bmin)

c8: (H, S, B)=(Hmax, Smax, Bmax)

Points pc1 to pc8 shown in FIG. 11 are points where these colors c1 to c8 are represented by the sRGB colorimetric system. In other words, points pc1 to pc8 are points are points corresponding to points c1 to c8 having, as the tone values of each component, the maximum value or the minimum value of the range in the HSB colorimetric system color space, which is to be modified for H, S, and B. Note that for the colors c1 to c8 represented by the HSB colorimetric system and the points in the sRGB color space (colors represented by the sRGB colorimetric system) pc1 to pc8, items having the same number such as c1 and pc1 do not necessarily have a corresponding relationship. Specifically, for example, there are cases when colors having different numbers such as c2 and pc7 are corresponding items. The RGB tone values (Vri1, Vgi1, Vbi1) to (Vri8, Vgi8, Vbi8) of points pc1 to pc8 correlated in advance to each memory color Cm1 to CmM and stored in the memory color table 105 (not illustrated in FIG. 3).

At step S252 in FIG. 10, a grid is specified that is contained in the range surrounded by the polyhedron having as vertices the points pc1 to pc8 corresponding to the memory colors of the subject memory color parameters Pmc determined at step S100. Then, the grid contained in the range surrounded by points pc1 to pc8 undergoes the processes of steps S254 to S258 noted below.

At step S254, the output tone values (Vro, Vgo, Vbo) that the grid has are converted to HSB colorimetric system tone values. Then, at step S256, the H, S, and B tone values represented by the HSB colorimetric system are modified.

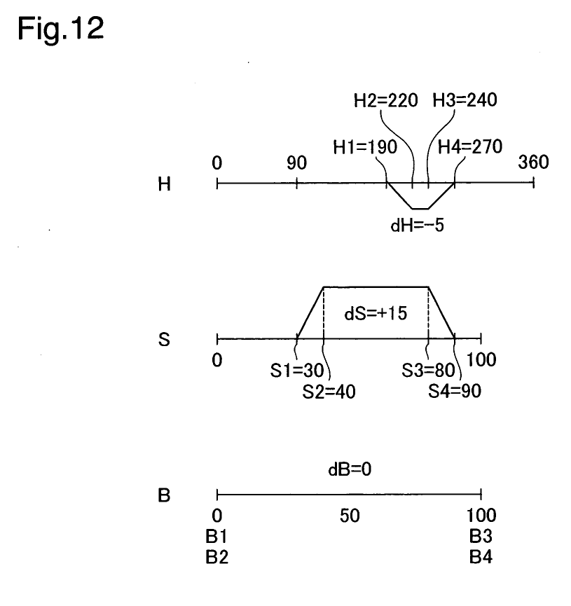

FIG. 12 shows an example of the details on the modification of the tone values at step S256. FIG. 12 shows the modification of color in the grid contained in Cm1 which is the color range of blue sky. The memory color range is H=H1 to H4, S=S1 to S4, and B=B1 to B4 (see FIG. 3). In the drawing, H2 and H3 are the tone values of the hues contained in the range of H1 to H4. S2 and S3 are the tone values of the saturation level contained in the range S1 to S4. B2 and B3 are the tone values of the brightness contained in the range B1 to B4.

When the hue H of the grid output color (meaning the color specified by the output tone value that the grid has) is in the range of H=H2 to H3, H is modified to (H+dH). In the example in FIG. 12, dH=−5. Then, for the range of H=H1 to H2, the modification level is set so that the closer the value of H is to H1, the lower the modification level, specifically, so that it approaches 0. Then, the modification level is set so that the closer the value of H is to H2, the closer the modification level is to dH. Also, for the range of H=H3 to H4, the modification level is set so that the closer the value of H is to H4, the lower the modification level, and the closer the value of H is to H3, the closer to dH.

Modification in this manner allows the output values of the three dimensional lookup table 104a to be determined in such a way as to avoid unnatural image colors, specifically, hues, when the image colors are adjusted with reference to the three dimensional lookup table 104a that has been generated.

Also, as shown by the middle level in FIG. 12, when the saturation S of the grid output color is in the range of S=S2 to S3, S is modified to (S+dS). In the example in FIG. 12, dS=+15. Then, for the range of S=S1 to S2, the modification level is set such that the closer the value of S is to S1, the lower the modification level, and the closer the value of S is to S2, the closer to dS. Also, for the range of S=S3 to S4, the modification level is set such that the closer the value of S to S4, the lower the modification level, and the closer the value of S to S3, the closer to dS.

Modification in this manner allows the output values of the three dimensional lookup table 104a to be determined in such a way as to avoid unnatural image colors, specifically, saturation levels, when the image colors are adjusted with reference to the three dimensional lookup table 104a that has been generated.

The same is true for brightness B as well. However, for the color range Cm1, the modification level dB is 0, so in the example in FIG. 12, B is not modified for the range of B=B1 to B4. However, when brightness is modified, modification by the same method as that for the hue and saturation noted above will allow the output values of the three dimensional lookup table 104a to be determined so as to avoid unnatural image color, specifically the brightness, when the colors are adjusted with reference to the three dimensional lookup table 104a that has been generated.

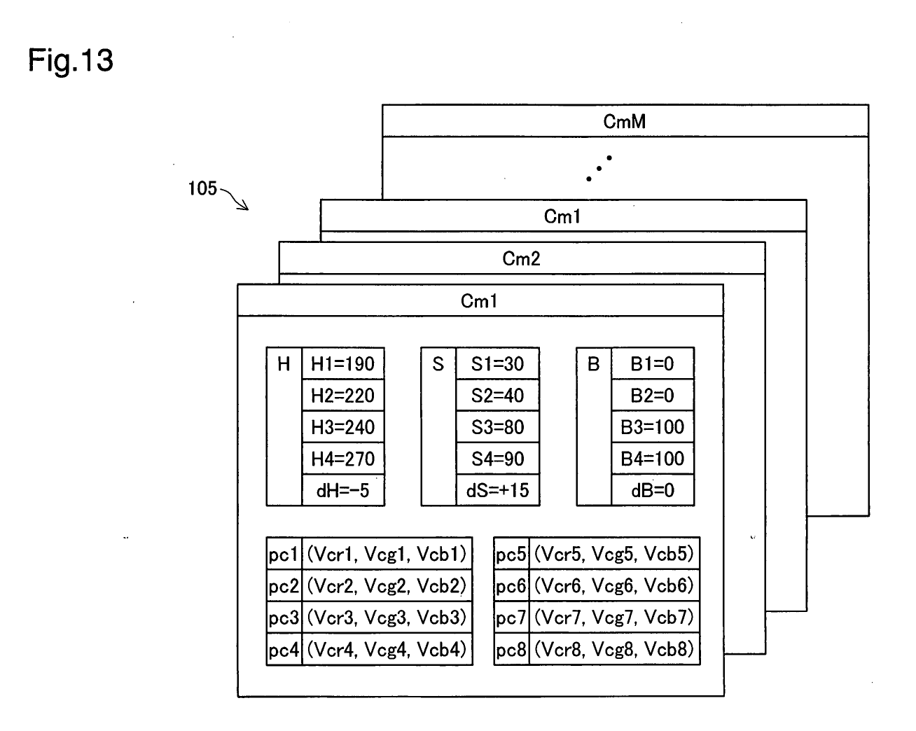

FIG. 13 shows the memory color table 105. The values of H1 to H4, dH, S1 to S4, dS, B1 to B4, and dB used for the aforementioned memory color adjustment, as well as the RGB tone values of points pc1 to pc8 described above (Vcr1, Vcg1, Vcb1) to (Vcr8, Vcg8, Vcb8) are stored in advance in the memory color table 105. Specifically, the memory color table 105 stores information such as that shown in FIG. 13. The LUT generating module 102 calculates the size of the area of each memory color based on this kind of memory color table 105 (see step S120 in FIG. 4), specifies the grid contained in the memory color range (see step S252 in FIG. 10), and modifies the output colors that the grid has (see step S256 in FIG. 10).

At step S258 of FIG. 10, the grid output colors modified in step S256 are converted to sRGB colorimetric system tone values to obtain the grid output colors. At step S260, it is determined whether or not the processes of steps S254 to S258 were performed for all the grids contained in the color range of the memory colors targeted for adjustment. Then, when there are grids for which the processes of the steps S254 to S258 have not yet been performed, the process returns to step S254 and the output colors for those grids are modified. The process is over when the processes of steps S254 to S258 have been performed for all the grids contained in the color range of the colors targeted for adjustment, which are surrounded by points pc1 to pc8.

At step S250 in FIG. 5, the output colors of the grids contained in the color range of the memory colors of the grids of the three dimensional lookup table 104c are adjusted using the kind of procedure described above, and the three dimensional lookup table 104a is generated (see step S200 in FIG. 1 and FIG. 2).

The three dimensional lookup table 104a generated in the first embodiment does not necessarily have the input tone values for all the tone values (e.g. 0 to 255). Specifically, the three dimensional lookup table 104a has only nine input tone values for each color component (see FIG. 9). Interpolation is done in cases where input tone values which are not in the three dimensional look up table 104a are converted when the color tone adjustment module 103 (see FIG. 1) generates the image data PIDr by converting the primary image data PID while referencing the three dimensional lookup table 104a. Specifically, of the grids that the three dimensional lookup table 104a does have, the four grids that are closest to the color targeted for conversion are selected, tetrahedron interpolation is performed, and the output tone positions of the input tone values that are to be converted are calculated from the output tone values of each color component that those grids have.

In the first embodiment, the three dimensional lookup table 104a does not have the output tone values for all the values that the input tone values of each color component can have, but rather has the output tone values only for part of the input tone values. Because of that, the data volume is lower than for aspects having output tone values for all the values that the input tone values of each color component can have.

Interpolation is also performed when converting the primary image data PID to the image data PIDr. In the first embodiment, when the three dimensional lookup table 104c which is the basis for the three dimensional lookup table 104a is generated, areas with a greater increase in output tone values in the tone curve will have greater input tone values (grids) than areas with less increase in the output tone value (see FIG. 8). Because of this, when referencing the lookup table 104a, even though the output tone values are obtained by interpolation in areas having a greater rate of change in output tone values the error is lower than with a three dimensional lookup table that has output tone values for equally spaced input tone values.

### B. Second Embodiment

In the first embodiment, the RGB tone curves were the same (see FIG. 6 and FIG. 8). However, in the second embodiment, the tone curves of each color component for adjusting the color tone are different from each other. Everything other than the method for generating the tone curve in the second embodiment is the same as the first embodiment.

In the second embodiment, the LUT generating module 102 calculates the average value Vra, Vga, and Vba and standard deviation σr, σg, and σb of each red, green, and blue tone value for the analysis of the reduced image data PID2 (see step S100 in FIG. 2).

Then, the LUT generating module 102 calculates the average tone value adjustment parameters dlr, dlg, and dlb for red, green, and blue according to the formulas (8), (9), and (10) below for the calculation of the tone curve setting parameters (see step S210 in FIG. 5). Vrc, Vgc, and Vbc are the target values of the average tone values of red, green, and blue, respectively, and for example, are the median values of each tone value (128 in the second embodiment).
dlr=a×(Vrc−Vra) (8)
dlg=a×(Vgc−Vga) (9)
dlb=a×(Vbc−Vba) (10)

Also, the LUT generating module 102 calculates the contrast adjustment parameters dcr, dcg, and dcb as the setting parameters using the formulas (11) to (16) below in step S210. The contrast adjustment parameters dcr, dcg, and dcb are the parameters for adjusting the image contrast for the three dimensional lookup table 104a that is ultimately generated. Note that b and σr0, σg0, and σb0 in the formulas (11) to (16) are positive constants. σr0, σg0, and σb0 are the target values of the standard deviation of the red, green, and blue tone values.
dcr=br×(σr0−σr) (when σr<σr0) (11)
dcr=0 (when σr≧σr0) (12)
dcg=bg×(σg0−ag) (when σg<σg0) (13)
dcg=0 (when σg≧σg0) (14)
dcb=bb×(σg0−σg[sic]) (when σb<σb0) (15)
dcb=0 (when σb≧σb0) (16)

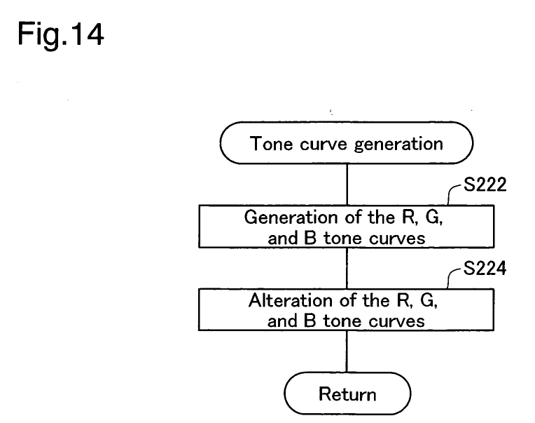

FIG. 14 is a flow chart showing the procedure of the tone curve generating method in the second embodiment. This flow chart shows the details of step S220 in FIG. 5 of the second embodiment. Of the processes on each red, green, and blue color component, red will be described as the example below.

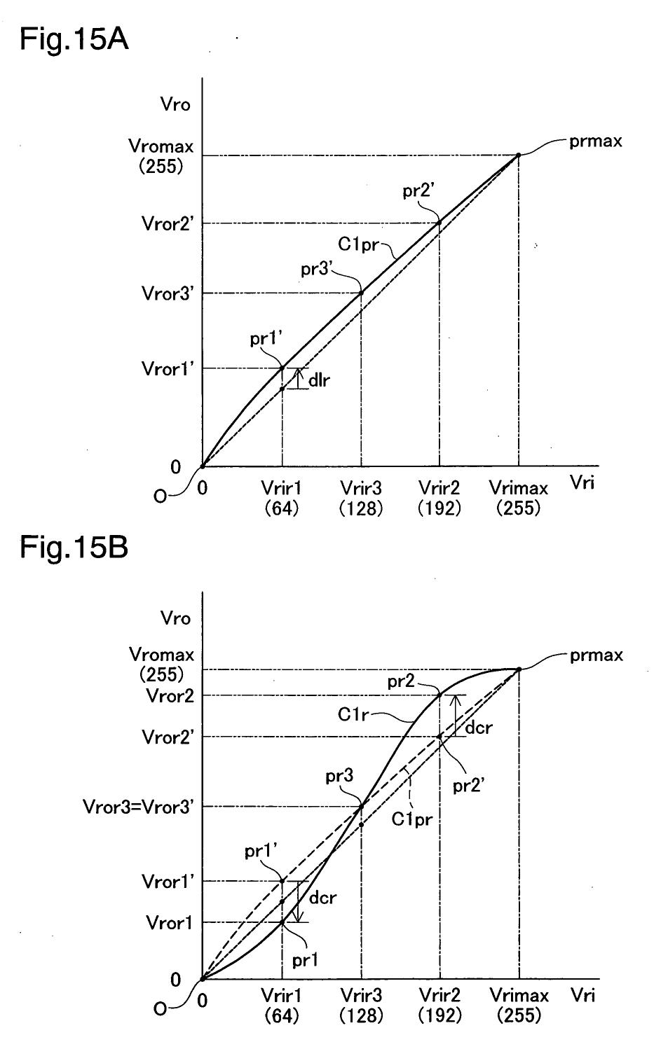

FIGS. 15A and 15B are drawings showing an example of the red tone curve generating method in step S222 in FIG. 14. The horizontal axis of each graph represents the red input tone values Vri, and the vertical axis represents the red output tone values Vro. The LUT generating module 102 generates the red tone curve based on the average tone value adjustment parameter dlr and the contrast adjustment parameter dcr in step S222. The method of generating the tone curve based on the setting parameters is about the same as the method of generating the tone curve based on the lightness in the first embodiment. Specifically, first, formula (17) below is used to determine the interim output tone value Vror1′ of the reference input tone value Vrir1=64 which is the tone value ¼ from the bottom in the range that the red input tone values can have.
Vror1′=Vrir1+dlr (17)

Then, the interim tone curve C1pr is generated as the spline curve that passes through point O (0, 0), point pr1′ (Vrir1, Vror1′), and point prmax (Vrimax, Vromax) (see FIG. 15A). Vrimax and Vromax are the maximum values of the red tone values, and are 255.

The LUT generating module 102 then employs formula (18) below to determine the output tone value Vror1 of the reference input tone value Vrir1=64 which is the tone value ¼ from the bottom for red.
Vror1=Vror1′−dcr (18)

Also, the LUT generating module 102 employs formula (19) below to determine the output tone value Vror2 of the reference input tone value Vrir2=192 which is the tone value ¼ from the top of the range that the red input tone values can have. Vror2′ is the output tone value of the reference input tone value Vrir2 for the interim tone curve C1pr generated based on the average tone value adjustment parameter dlr.
Vror2=Vror2′+dcr (19)

Meanwhile, the LUT generating module 102 treats the output tone value Vror3 of the reference input tone value Vrir3=128, which is the tone value ½ from the bottom, as equivalent to the output tone value Vror3′ of the reference input tone value Vrir3 for the interim tone curve noted above.

Then, the LUT generating module 102 generates the red tone curve C1r as the spline curve that passes through point O (0, 0), point pr1 (Vrir1, Vror1), point p3r (Vrir3, Vror3), point p2r (Vrir2, Vror2), and point prmax (Vrimax, Vromax).

The generation of the red tone curve was described above, but the same is also true for the green and blue tone curves. The tone curve of each color component is generated based on the average value and the standard deviation of the tone value of each respective color component. Because of this, the shape of each tone curve is different.

In step S222, when each red, green, and blue tone curve is generated, the LUT generating module 102 adjusts the shape of each red, green, and blue tone curve.

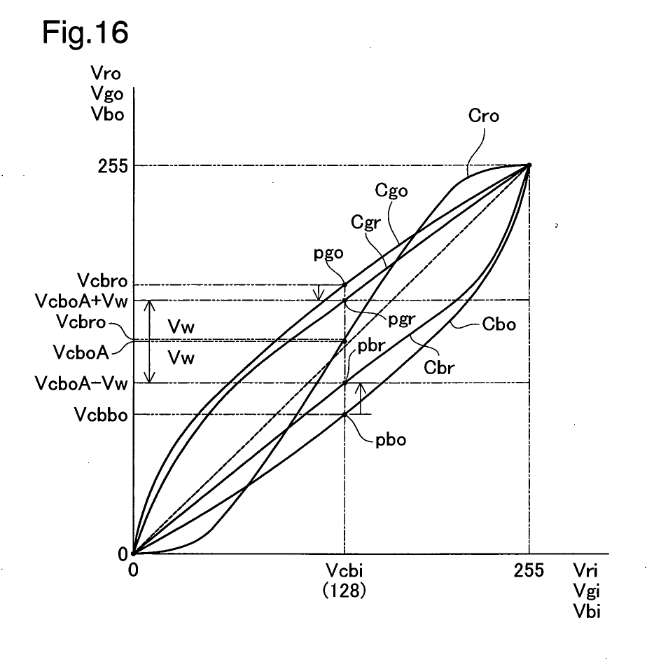

FIG. 16 shows an example of the method for altering the tone curve in step S224 in FIG. 14. The LUT generating module 102 calculates the red, green, and blue tone curve output tone values Vcbro, Vcbgo, and Vcbbo corresponding to the specified input tone value Vcbi based on each red, green, and blue tone curve generated in step S222. Then, the average value VcboA of the output tone values Vcbro, Vcbgo, and Vcbbo is calculated. In the second embodiment, the input tone value Vcbi is the median value 128 of the range that can be used for the input tone value of each color component.

If the output tone values Vcbro, Vcbgo, and Vcbbo of the red, green, and blue tone curves corresponding to the input tone value Vcbi are not in the plus/minus Vw range centered on the average value VcboA, the output tone values which are not in that range are modified.

When the output tone value Vcbo corresponding to the input tone value Vcbi of a certain tone curve is greater than (VcboA+Vw), the LUT generating module 102 modifies that output tone value Vcbo to (VcboA+Vw). The output tone values corresponding to the other input tone values are each rendered c1-fold (c1>0). c1 is a number for which the closer its input tone value is to Vcbi, the closer it is to (Vcb0A+Vw)/Vcb0, and the closer its input tone value is to 0 or Vimax, the closer it is to 1.

In the example in FIG. 16, the green tone curve Cgo is modified in this manner. In FIG. 16, unmodified the green tone curve is indicated by Cgo, and the modified green tone curve is indicated by Cgr. In FIG. 16, the point on the unmodified tone curve Cgo corresponding to the input tone value Vcbi is indicated by pgo, and its output tone value is indicated by Vcbgo. The point on the modified tone curve Cgr corresponding to the input tone value Vcbi is indicated by pgr.

When the output tone value Vcbo corresponding to the input tone value Vcbi of a certain tone curve is smaller than (VcboA−Vw), the LUT generating module 102 modifies that output tone value Vcbo to (VcboA−Vw). The output tone values corresponding to the other input tone values are each rendered c2-fold (c2>0). c2 is a number for which the closer its input tone value is to Vcbi, the closer it is to (Vcb0A−Vw)/Vcb0, and the closer its input tone value is to 0 or Vimax, the closer it is to 1.

In the example in FIG. 16, the blue tone curve Cbo is modified in this manner. In FIG. 16, the unmodified blue tone curve is indicated by Cbo, and the modified blue tone curve is indicated by Cbr. In FIG. 16, the point on the unmodified blue tone curve Cbo corresponding to the input tone value Vcbi is indicated by pbo, and its output tone value is indicated by Vcbbo. The point on the modified tone curve Cbr corresponding to the input tone value Vcbi is indicated by pbr.

In step S224 in FIG. 14, the tone curve is thus modified such that the variation of the output tone values for the central vicinity of the input tone values for each tone curve are within a specified range. This process can prevent substantial changes in hue before and after conversion when colors are adjusted according to the tone curve, specifically, when colors are converted according to the three dimensional lookup table 104a that is ultimately generated.

The following three dimensional lookup table 104a is generated using the same procedure as the first embodiment based on the generated red, green, and blue tone curves. Because the shapes of the red, green, and blue tone curves are different from each other, there are also cases when a different number of input tone values of each tone curve are selected as the input tone value of the three dimensional lookup table 104c. In this embodiment as well, images can be processed with fewer errors using the three dimensional lookup table 104a with low data volume.

C. Variants

The present invention is not limited to the embodiments and examples noted above, and a variety of embodiments are possible within the scope of the invention.

C1. Variant 1:

In the embodiments noted above, when the input tone values corresponding to a difference dvk greater than the threshold value Th are over the specified number L, the specified number L of input tone values is selected from those with the greater difference, and they are used for at least some of the input tone values that the lookup table has (see step S238 in FIG. 7). However, determination of the input tone value is not limited to this kind of method, but can also be done using another method.

For example, it is also possible to select input tone values correlated to a difference greater than the threshold value Th for all the input tone values of the lookup table. It is also possible to select N input tone values correlated N largest differences as the lookup table input tone values without determining the magnitude relative to a threshold value.

Specifically, when the selection of the lookup table input tone values involves dividing candidate input tone values at a certain stage into a first group with a greater rate of increase in the output tone values correlated to each input tone value and a group with a lower rate of increase than that of the first group, at least some of the input tone values of the first group with the greater rate of increase rate may be selected as at least some of the input tone values of the lookup table. In this embodiment, the lookup table input tone values are set for output tone values with greater change in relation to the change in input tone values. As a result, interpolation is less likely to result in a loss of image quality when using the lookup table for color tone adjustment (see the color tone adjustment module 103 in FIG. 1).

C2. Variant 2:

When the look up table input tone values are determined in the embodiments noted above, for a plurality of constantly spaced input tone values among the tone curve input tone values, the correlated difference in the output tone value from the next smaller input tone value is determined. Then, based on the magnitude of that difference, the lookup table input tone values are determined. However, it is also possible to determine the lookup table input tone values using other methods.

For example, for candidate input tone values at given intervals, the correlated difference in the output tone value from the next bigger input tone value maybe calculated. The lookup table input tone values can be determined based on the magnitude of the difference. It is also possible to determine the increase in the output tone values in relation to the increase in the input tone values which is lower than the interval of the candidate input tone values, and to determine the lookup table input tone values based on the magnitude of the increase in the output tone values. Specifically, the lookup table input tone values can be determined based on the rate of increase in the tone curve output tone values. Here, the “rate of increase” in the output tone values is the extent to which the output tone values increase in relation to the constant level of increase in the input tone values.

C3. Variant 3:

The lookup table input tone values can also include input tone values other than those determined based on the rate of increase in the tone curve output tone values. For example, after generating the three dimensional lookup table, when modifying the output tone values of the grid contained in part of the area in three dimensional space (see step S250 in FIG. 5, and FIG. 10 and FIG. 11), it is possible to determine the input tone values positioned at the boundary of that area as the input tone values of the lookup table when generating the three dimensional lookup table.

C4. Variant 4:

In the embodiments noted above, when determining the tone curve of each color component based on the analysis results of the reduced image data, processing for the purpose of adjusting the brightness and processing for the purpose of adjusting the contrast are performed (see FIG. 6 and FIG. 15). However, when determining the tone curve of each color component, it is also possible to perform other processing. For example, it is also possible to form tone curves such that the minimum output tone value Vomin is output for the specified range of input tone values including the minimum input tone value Vimin. Then, it is also possible to form tone curves such that the maximum output tone value Vomax is output for the specified input tone value range including the maximum input tone value Vimax.

Also, in the embodiments noted above, the adjustment level (adjustment parameter) for determining the tone curve shape is determined using the target average values and the target standard deviation for the lightness and color component tone values (see formulas (2), (4), (8) to (11), (13) and (15)). However, the operating level when determining the tone curve shape can also be determined based on other levels. For example, it is also possible to determine the adjustment level based on the maximum value or the minimum value of the lightness or color component tone values. Specifically, the tone curve can be generated based on the direct or indirect analysis results of image data that is subject to image processing.

C5. Variant 5:

In the embodiments described above, the primary image data PID and the reduced image data PID2 are image data represented by the color of each pixel in the sRGB colorimetric system. However, the image data that is subject to processing can also be image data represented by the colors of another colorimetric system such as the xyz colorimetric system, the L*a*b* calorimetric system, or the L*u*v* colorimetric system.

C6. Variant 6:

In the embodiments noted above, the color adjustment in relation to the memory colors is performed by once converting a combination of sRGB colorimetric system output tone values to a combination of HSB calorimetric system output tone values, modifying the output tone values of the HSB calorimetric system, and converting back to a combination of sRGB calorimetric system output tone values. However, when modifying some of the colors such as color adjustment in relation to memory colors or the like, it is also possible to change to another colorimetric system such as the L*a*b* colorimetric system or the L*u*v* colorimetric system. However, it is preferable that the calorimetric system after conversion be a colorimetric system that contains tone values in relation to lightness as one tone value. In this embodiment, it is possible to perform color adjustment such that the brightness and the hue and saturation may be changed separately according to human vision.

C7. Variant 7:

When determining the lookup table input tone values based on the tone curve of each color component, the threshold value Th and the input tone value count Nmax can be made different for each color component. For example, for color components with less change in the rate of increase in the output tone values in the tone curve, it is possible to set the input tone value count Nmax lower than for color components with greater change in the rate of increase in the output tone values in the tone curve.

C8. Variant 8:

When generating the tone curve of each color component in the embodiments noted above, tone curves are given the function of adjusting the image brightness by modifying the output tone values for the tone values ¼ from the bottom of the range which the input tone values can have (see FIG. 6A). However, when giving the brightness adjustment function to the tone curve, it is also possible to perform this by modifying the output tone values correlated to the other input tone values such as modifying the output tone values in relation to the tone values ⅓ or ½ from the bottom. Specifically, when tone curves are given the brightness adjusting function, this can be done by modifying the output tone values corresponding to specified input tone values.

Also, in the embodiments noted above, when generating the tone curve of each color component, tone curves can be given the function of modifying the output tone values in relation to the tone values ¼ from the bottom to ¼ from the top in the range which the input tone values can have, to adjust the contrast (see FIG. 6B). However, when tone curves are given the function of adjusting the image contrast, this can be done by modifying the output tone values corresponding to other input tone values such as modifying the output tone values for the tone values ⅓ or ½ from the bottom, then of the tone values ⅓ or ½ from the top.

Specifically, when tone curves are given the contrast adjustment function, this can be done by reducing the output tone values corresponding to the specified first input tone values, and by increasing the output tone values corresponding to specified second input tone values which are larger than the first input tone values. In that case, when modifying the first and second input tone values, it is preferable not to modify the output tone values for the third input tone values which are greater than the first input tone values and smaller than the second input tone values.

Furthermore, when determining the shape of the tone curve, it is possible to determine the tone curve shape by considering other elements. The tone curve may be determined such that the input tone values of each color component representing colors of a specified range such as skin color are close to the tone values of each color component representing the target color. Specifically, tone curves can be automatically generated based on the primary image data PID or the reduced image data PID2.

C9. Variant 9:

In the first embodiment, first, the first candidate tone values are determined based on the tone curve shape, and after that, the second candidate tone values are determined based on the subject memory color (see steps S310 and S320 in FIG. 7). However, the first and second candidate tone values can be determined with one or the other determined first, or can also be determined in parallel.

C10. Variant 10:

In the first embodiment, the second candidate tone values are tone values of colors that determine the color range for modifying the output tone values based on the memory colors (see FIG. 11 and FIG. 13). However, the second candidate tone values can also be tone values determined based on other factors. Specifically, in embodiments where output tone values for some of the color range are modified after the three dimensional look up table has been generated, the second candidate tone values can be tone values determined based on parameters that determine the color range for their modification.

For example, when the color range for modifying output tone values is a spherical color range determined by the tone values of each color component representing the central point color and the size of the radius, the second candidate tone values can be tone values determined based on the tone values of each color component representing the color of the center point and on the size of the radius. However, the second candidate tone values are preferably the tone values of the colors positioned on the boundary of the color range for the aforementioned modification of the color space determined by the input tone values of the lookup table.

C11. Variant:

In the first embodiment, the first candidate tone values in the range of plus/minus dn of the second candidate tone values are excluded from the first candidate tone values (see step S340 in FIG. 7). Then, dn is 4. However, when excluding first candidate tone values having values close to the second candidate tone values, it is possible to use another reference. For example, the value dn that is the reference for whether or not an item is in the vicinity of the second candidate tone values can also be determined by the ratio to the interval di of the first candidate tone values. dn is preferably a value that is less than 30% of the interval di of the first candidate tone values, and more preferably a value that is less than 20% of di. Then, it is preferable that dn be a value that is less than 15% of the interval di of the first candidate tone values.

C12. Variant 12:

In the embodiments noted above, when generating the tone curve, it is generated using a spline curve that passes through the point that is the reference. However, when the tone curve is generated, it can also be generated using another curve such as the (m+1) level curve such as one that passes through m (m is an integer of 3 or greater) points as the reference.

C13. Variant 13:

In the embodiments described above, the maximum count L2 of the first candidate tone values based on the difference dvk is 7. Then, the maximum count Nmax of the input tone values of the three dimensional lookup table 104a is 17. However, it is also possible to use another number as the maximum count L2 of the first candidate tone values and as the maximum count Nmax of the input tone values of the three dimensional lookup table 104a. However, it is preferable to have a relationship of L2=Nmax−2−2ⁿ. Here, n is the number of color components that the primary image data PID has. Thus, 2ⁿ is the number of points that determine each color range Cmi (see FIG. 13). For example, when the primary image data PID that is the processing subject is sRGB colorimetric system image data, n=3, so L2=Nmax−10.

C14. Variant 14:

In the embodiments noted above, the lookup table is generated based on the tone curve by analyzing the reduced image data and determining the tone curve shape based on the analysis results (see FIG. 5). However, when generating the lookup table based on the reduced image data analysis results, another possible embodiment involves generating the lookup table without modifying the tone curve shape based on the analysis results.

For example, as described in the first embodiment, there are cases specific modification of colors in specified ranges such as tree green, sky blue (see FIG. 3 and FIG. 11). In such a case, the reduced image data generated from the image data subject to processing is analyzed to determine which range of colors should be processed and which range of colors should not be processed (see step S100 in FIG. 1), and it is also possible to generate the n dimension lookup table based on that determination. When doing that, another possible embodiment involves generating the tone curve that is the basis of the n dimension lookup table without basing it on the reduced image data analysis results.

Specifically, as an aspect of the present invention, when generating the lookup table using image conversion, it is possible to directly or indirectly reflect the analysis results of the reduced image data of the image data subject to conversion to generate the lookup table.

C15. Variant 15:

In the embodiments noted above, the three dimensional lookup table 104a is generated based on the reduced image data PId1 that is generated by reducing the primary image data PID. However, in other embodiment, it is also possible to do sampling of part of the primary image data PID for analysis, and to generate the lookup table used when adjusting the image based on those analysis results. Specifically, the lookup table for color adjustment of the image data can be generated based on image data that is directly or indirectly subject to processing.

C16. Variant 16:

In the embodiments noted above, when referencing the lookup table 104a, tetrahedron interpolation is performed. However, when referencing the lookup table 104a, it is also possible to employ other forms of interpolation, such as tetrahedral interpolation or the like in which interpolation is using the output tone values of the 6 grids that enclose the conversion subject color points when referencing the lookup table 104a.

C17. Variant 17:

The extent to which the tone values of the HSB colorimetric system are modified to adjust tone, as in the above embodiments, may be values predetermined for the tone values of the HSB calorimetric system (see FIG. 14). The calculation formulas may also be predetermined, and the level of modification may be calculated by substituting the tone values of the HSB calorimetric system in those calculation formulas. The latter embodiment is included in embodiments in which size is modified by “predetermined levels” according to the tone values. Note that the “predetermined level” according to the tone value can also be 0.

C18. Variant 18:

In the embodiments noted above, the three dimensional lookup table 104c is determined such that the grid is formed by the points on the color space of the sRGB colorimetric system corresponding to the combination of the edges of the range for modifying the hue (H), saturation (S), and brightness (B) (see H1, H4, S1, S4, B1, and B4 in FIG. 14) of the HSB colorimetric system which is a colorimetric system containing the lightness gradations. However, when generating the n dimension lookup table referenced during color adjustment, the n dimension look up table should be generated by determining the input tone values such that the grid is formed by the points on the color space corresponding to the combination of the edges of the range for a certain level of modification level (see H2, H3, S2, S3, B2, and B3 in FIG. 14). In this embodiment, as described above, it is especially preferable to determine the input tone values of the lookup table based on the color range for color modification.

Note that embodiments such as the following are also possible for the n dimension lookup table. Specifically, the n dimension lookup table does not have output tone values for a combination of all the input tone values, but rather has output tone values for a combination of a part of the input tone values. Then, when referencing the n dimension lookup table, the plurality of output tone values held by the n dimension lookup table are read, the interpolation operation is performed using those, and these are used for image processing. In this embodiment, as described above, it is especially preferable to determine the lookup table input tone values based on the color range for performing color alteration.

C19. Variant 19:

In the embodiments noted above, parts realized by hardware may be replaced with software, and conversely, parts realized by software may be replaced by hardware. For example, it is possible to have a hardware circuit execute part of the functions of the printer driver 96 (see FIG. 2).

Computer program that realize these kinds of functions may be recorded on a computer readable recording medium such as a floppy disk, CD-ROM or the like. The host computer reads the computer program from that recording medium and transfers it to an internal storage device or external storage device. Alternatively, it is also possible to supply the computer program to the host computer from a program supplying device via a communication path. When realizing the computer program functions, the computer program stored in the internal storage device is executed by a microprocessor in the host computer. It is also possible to have the host computer directly execute the computer program recorded in the recording medium.

In this specification, the host computer is a concept including a hardware device and an operating system, and means a hardware device that operates under the control of the operating system. The computer program realizes the function of each part described above on this kind of host computer. Note that part of the functions described above can also be realized by the operating system rather than the application program.

Note that in this invention, a “computer readable recording medium” is not limited to a portable recording medium such as a flexible disk or CD-ROM, but also includes internal storage devices within a computer such as various types of RAM, ROM or the like, or external storage devices attached to a computer such as a hard disk or the like.

The Program product may be realized as many aspects. For example:

(i) Computer readable medium, for example the flexible disks, the optical disk, or the semiconductor memories;

(ii) Data signals, which comprise a computer program and are embodied inside a carrier wave;

(iii) Computer including the computer readable medium, for example the magnetic disks or the semiconductor memories; and

(iv) Computer temporally storing the computer program in the memory through the data transferring means.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

What is claimed is:

1. An image processing device, comprising:
a reduced image data generating unit that reduces an image of a first image data to generate second image data;
a lookup table generating unit that analyzes the second image data and generates a lookup table based on the analysis, the lookup table being a table for image conversion that alters at least part of color of image data; and
an image conversion unit that convert the first image data by referencing the lookup table.

2. A device in accordance with claim 1, wherein
the first image data contains tone values of n color components (n is an integer of 2 or more),
the lookup table is an n dimension lookup table having combinations of tone values of the n color components as input values and output values respectively, and
the lookup table generating unit
generates n tone curves based on the analysis, the n tone curves respectively having discrete tone values of one of the n color components as input tone values and output tone values,
generates the n dimension lookup table based on the n tone curves, the n dimension lookup table being an n dimension table for which a number of tones of input values is lower than the tone curve for at least one color component, and
when at least part of the input tone values of the tone curve are predetermined as candidates of the input tone values for the n dimension lookup table and are divided into a first group and a second group for which corresponding output tone value increase rate is larger than that of the first group, determines input tone values in the second group as at least part of the input tone values of the n dimension lookup table.

3. A device in accordance with claim 2, wherein
the lookup table generating unit
for a plurality of input tone values as the candidates which have a fixed interval among the input tone values of the tone curve, calculates as the output tone value increase rate a difference of the output tone values between each input tone value and adjacent input tone value while associating with each input tone value, and
determines the input tone values of the second group as at least part of the input tone values of the n dimension lookup table, the second group being a group for which the associated difference is larger than that of the first group.

4. An image processing device in accordance with claim 3, wherein
the lookup table generating unit selects input tone values associated with differences greater than a predetermined threshold as the input tone values of the n dimension lookup table.

5. An image processing device in accordance with claim 3, wherein
the lookup table generating unit selects as at least part of the input tone values of the n dimension lookup table LS input tone values (LS is a positive integer and equal or less than a predetermined positive integer L) which are associated with LS largest differences from among the plurality of input tone values having the fixed interval.

6. An image processing device in accordance with claim 3, wherein
in generating at least one of the n tone curves, the lookup table generating unit
determines a reference output tone value Vor associated with a reference input tone value Vir based on the analysis, and
determines output tone values associated with input tone values other than the reference input tone value Vir such that an output tone value Voa associated with an input tone value Via is closer to the reference output tone value Vor than an output tone value Vob associated with an input tone value Vib, wherein

|Via−Vir|<|Vib−Vir| and
(Via−Vir)×(Vib−Vir)>0.

7. An image processing device in accordance with claim 3, wherein
in generating at least one of the n tone curves, the lookup table generating unit
decreases a first reference output tone value Vor1 associated with a first reference input tone value Vir1 based on the analysis,
increases a second reference output tone value Vor2 associated with a second reference input tone value Vir1 based on the analysis, the second reference input tone value Vir2 being larger than the first reference input tone value Vir1, and
determines output tone values associated with input tone values other than the first reference input tone value Vir1 and the second reference input tone value Vir2 such that
an output tone value Voa associated with an input tone value Via is closer to the reference output tone value Vor1 than an output tone value Vob associated with an input tone value Vib, wherein

|Via−Vir1|<|Vib−Vir1| and
(Via−Vir1)×(Vib−Vir1)>0
an output tone value Voc associated with an input tone value Vic is closer to the reference output tone value Vor2 than an output tone value Vod associated with an input tone value Vid, wherein

|Vic−Vir2|<≡Vid−Vir2| and
(Vic−Vir2)×(Vid−Vir2)>0.

8. An image processing device in accordance with claim 3, wherein
in generating the n tone curves, the lookup table generating unit
determines within a specified range reference output tone values Vori (i=1 to n) respectively associated with a same reference input tone value Vir in the n tone curves, and
determines output tone values associated with input tone values other than the reference input tone value Vir such that an output tone value Voai (i=1 to n) associated with an input tone value Viai (i=1 to n) is closer to the reference output tone value Vori than an output tone value Vobi (i=1 to n) associated with an input tone value Vibi (i=1 to n) in generating the ith tone curve, wherein

|Viai'Vir|<|Vibi−Vir| and
(Viai−Vir)×(Vibi−Vir)≧0.

9. An image processing method, comprising:
reducing an image of a first image data to generate second image data;
analyzing the second image data and generating a lookup table based on the analysis, the lookup table being a table for image conversion that alters at least part of color of image data; and
converting the first image data by referencing the lookup table.

10. A method in accordance with claim 9, wherein
the first image data contains tone values of n color components (n is an integer of 2 or more),
the lookup table is an n dimension lookup table having combinations of tone values of the n color components as input values and output values respectively, and
generating the lookup table includes:
generating n tone curves based on the analysis, the n tone curves respectively having discrete tone values of one of the n color components as input tone values and output tone values,
generating the n dimension lookup table based on the n tone curves, the n dimension lookup table being an n dimension table for which a number of tones of input values is lower than the tone curve for at least one color component, and
when at least part of the input tone values of the tone curve are predetermined as candidates of the input tone values for the n dimension lookup table and are divided into a first group and a second group for which corresponding output tone value increase rate is larger than that of the first group, determining input tone values in the second group as at least part of the input tone values of the n dimension lookup table.

11. A computer program product for image processing comprising:
a computer readable medium; and
a computer program stored on the computer readable medium, the computer program comprising:
a portion for reducing an image of a first image data to generate second image data;
a portion for analyzing the second image data and generates a lookup table based on the analysis, the lookup table being a table for image conversion that alters at least part of color of image data; and
a portion for converting the first image data by referencing the lookup table.
